(19) United States
(12) Patent Application Publication
(10) Pub. No.: US 2015/0163656 A1
(43) Pub. Date: Jun. 11, 2015

(54) WIRELESS LOCAL AREA NETWORK SYSTEM BASED ON AN ACCESS POINT (AP) SUPPORTING WIRELESS TERMINAL ROAMING

(71) Applicants: Hee-Jong Son, Yongin-si (KR); Han-Koon Nam, Hanam-si (KR); Sung-Man Park, Yongin-si (KR); Jae-Woo Park, Gunpo-si (KR); Hyuk-Soo Jin, Seoul (KR)

(72) Inventors: Hee-Jong Son, Yongin-si (KR); Han-Koon Nam, Hanam-si (KR); Sung-Man Park, Yongin-si (KR); Jae-Woo Park, Gunpo-si (KR); Hyuk-Soo Jin, Seoul (KR)

(73) Assignee: KT CORPORATION, Seongnam-si (KR)

(21) Appl. No.: 14/009,227

(22) PCT Filed: Oct. 19, 2011
(86) PCT No.: PCT/KR11/07806

§ 371 Date: Oct. 1, 2013

(30) Foreign Application Priority Data
Apr. 1, 2011 (KR) 10-2011-00030383

(51) Int. Cl. H04W 8/02

(52) U.S. Cl. CPC H04W 8/02; H04W 84/12

(57) ABSTRACT

A wireless local area network (WLAN) system is disclosed. The WLAN system includes a first access point (AP), and a second AP which has a same service set identifier (SSID) as that of the first AP, wherein the first AP and the second AP are configured to respectively perform a network address translation (NAT) and have a same virtual media access control (MAC) address. The WLAN system according to the present disclosure supports successful roaming between APs which belong to different networks regardless of the type of the wireless terminal.

### CROSS-REFERENCE TO RELATED PATENT APPLICATIONS

This is a national stage application of PCT/KR2011/007806, filed on Oct. 19, 2011, which claims priority from Korean Patent Application No. 10-2011-0030383, filed on Apr. 1, 2011, in the Korean Intellectual Property Office, the disclosures of which are hereby incorporated herein in their entireties by reference.

### BACKGROUND

1. Technical Field

Exemplary embodiments relate to a wireless local area network, and more particularly, to a wireless local area network system which supports roaming to another network while moving regardless of the type of a wireless terminal.

2. Description of Related Art

As wireless terminals are widely distributed and mobile communication networks are developed, the amount of use of mobile Internet, which connects to a website or a blog using a mobile wireless terminal, is rapidly increasing. A wireless short range network or a wireless local area network (WLAN) environment, which allows mobile Internet, requires seamless communication with a user. As such, the importance of roaming in a WLAN based on IEEE 802.11 standards is being highlighted. The IEEE 802.11 standards are marketed under the brand name Wi-Fi, which is an abbreviation of “wireless fidelity”. Wi-Fi or WLAN refers to a LAN that is wireless, and thus there is a limit in distance covered by the LAN. The communication speed decreases as the wireless terminal gets farther from an access point (AP), and if the wireless terminal completely deviates from the range, a disconnection occurs. Roaming is a function of moving connection from one AP to another AP while maintaining network connection of the wireless terminal. A plurality of APs, which provide the same service set ID (SSID) so that the SSIDs may sufficiently overlap, need to be distributed for seamless, flexible roaming. In the WLAN connection service, which uses a conventional AP and wireless terminal, even though AP cells overlap, if the wireless terminal is moved between the AP cells, the Internet is disconnected because each AP forms one sub-network in the current network address. That is, the network areas of AP1 and AP2 are different. If the wireless terminal is allocated an IP address from the AP1 and moves to the area of the AP2, the network address of the AP1 is not processed in the area of the AP2, and thus the connection to the Internet is not made.

FIG. 1 is a block diagram illustrating a WLAN system according to a related art. Referring to FIG. 1, a conventional WLAN system 100 includes a first AP 110, a second AP 112, a switch 120, and a router 140. In detail, the first AP 110 and the second AP 112 are connected to the router 140 via the switch 120, and is connected to an Internet company network (KORNET) 160 through the router 140. The first AP 110 operates in a bridge scheme, and the second AP 112 operates in a network address translation (NAT) mode. The first AP 110 and the second AP 112 have a unique media access control (MAC) address allocated by each manufacturing company. Generally, the AP operates in a bridge scheme or a NAT scheme. The bridge scheme operates as a simple switching hub. Hence, a service, such as a dynamic host configuration protocol (DHCP) which is set in a MODEM or upper L3 equipment, is only transmitted to the wireless terminal. The AP, which operates as the bridge scheme receives the network setting from, for example, a 3-layer router or an L3 switch, which is upper-end equipment, and thus the AP performs a function of only changing the signals into wireless signals. That is, the wireless terminal, which is connected to the first AP 110 that operates in the bridge mode, is allocated an IP address by the router 140. That is, the router 140 becomes a DHCP server, and the first AP 110 becomes a DHCP client. Furthermore, according to the NAT scheme, the AP itself serves as a DHCP server, which receives a public IP and provides the public IP to wireless terminals, as the private IP. That is, the AP becomes the DHCP server, and wireless terminals become the DHCP client. Consequently, the AP, which operated in the NAT mode, becomes a kind of router which connects to different networks. The wireless terminal, which is connected to the second AP 112 that operates in the NAT mode, is allocated the IP address from the second AP 112. Consequently, the first AP 110 and the second AP 112 are connected to the same router 140, but the second AP 112 is in the NAT mode, and thus the WLAN system 100 of FIG. 1 is allocated the IP address by different DHCP servers. The first AP 110 and the second AP 112 belong to different networks and the wireless terminal moves during connection to the first AP 110, and thus a new IP address needs to be allocated to maintain connection in order to connect to the second AP 112. A new IP address needs to be allocated to connect to a new network other than a current network while the wireless terminal is moving. If the wireless terminal requests a new IP address (broadcasts a DHCP discover) when roaming between adjacent APs, which belong to different networks, an IP address in a new network is allocated, and thus successful roaming becomes possible. However, when the wireless terminal requests an Internet connection with the existing IP address without requesting a new IP address, the existing IP address is not processed in a new network, and thus a disconnection occurs and roaming fails. Consequently, the success of roaming in the WLAN system is determined according to whether a function of requesting an IP address allocation is automatically supported if the wireless terminal tries connection with an AP, which belongs to another network. As, a result, this causes a problem that the user of a particular wireless terminal cannot be provided a seamless mobile communication service. Hence, there is a need for a WLAN system which may support successful roaming regardless of the type of the wireless terminal.

### SUMMARY

Exemplary embodiments provide a wireless local area network system which supports roaming to another network regardless of the type of a wireless terminal.

According to an aspect of an exemplary embodiment, there is provided a wireless local area network system which successfully supports roaming between APs that belong to different networks regardless of the type of the wireless terminal by applying the NAT mode to the AP.

According to a wireless local area network system according to an exemplary embodiment, seamless roaming may be possible and the problem of lack of IP may be resolved by applying a NAT mode to an access point. Furthermore, a separate DHCP server is not necessary, and thus the investment costs for the DHCP server may be reduced. Roaming at the access point end is realized, and thus AP equipment is not necessary. Also, a change in the circuit configuration of the conventional wireless network is not necessary.

According to one or more exemplary embodiments, a wireless local area network (WLAN) system based on an access point (AP) includes: a first AP; and a second AP which has a same service set identifier (SSID) as that of the first AP, wherein the first AP and the second AP are configured to respectively perform a network address translation (NAT) and have a same virtual media access control (MAC) address.

The first AP and the second AP may be configured to generate the virtual MAC address according to a predetermined scheme.

The virtual MAC address may be generated based on an original MAC address which has been set at a time of manufacturing.

The first AP and the second AP may be connected to a first router via a first switch.

The first AP may be connected to a first router via a first switch, and the second AP may be connected to the first router via a second switch.

The first AP may be connected to a first router via a first switch, and the second AP may be connected to a second router via a second switch.

The first router may be configured to function as a dynamic host configuration protocol (DHCP) server having an internet protocol (IP) address pool of a first class or a second class.

The first AP and the second AP may be respectively configured to function as a DHCP server having the IP address pool of the first class and the second class.

The first router and the second router may be respectively configured to function as a DHCP server having the IP address pool of the first class and the second class.

### BRIEF DESCRIPTION OF THE DRAWINGS

The above and other features and advantages of the exemplary embodiments will become more apparent with reference to the attached drawings.

FIG. 1 is a block diagram of a conventional wireless local area network system.

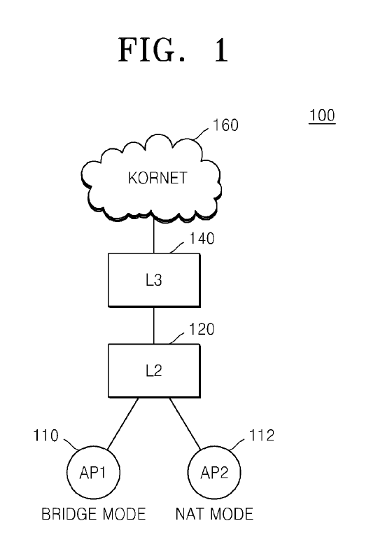

FIG. 2 is a block diagram of a wireless local area network system according to an exemplary embodiment.

FIG. 3 is a block diagram of a wireless local area network system according to another exemplary embodiment.

FIG. 4 is a block diagram of a wireless local area network system according to another exemplary embodiment.

### DETAILED DESCRIPTION

The attached drawings for illustrating exemplary embodiments are referred to in order to gain a sufficient understanding of the exemplary embodiments, the merits thereof, and the objectives accomplished by the implementation of the exemplary embodiments.

The exemplary embodiments may be modified in various different forms, and the scope of the present invention is not limited to the exemplary embodiments described below. Rather, the exemplary embodiments are provided to complete the present disclosure and completely let those of ordinary skill in the art understand the concept of the present invention.

Hereinafter, exemplary embodiments will be described in detail with reference to the attached drawings.

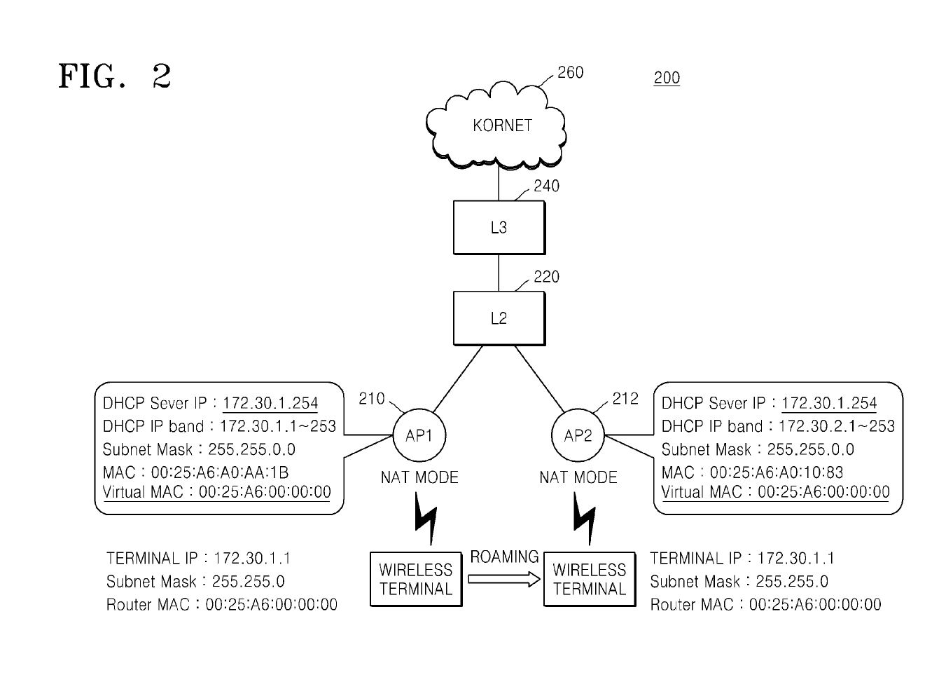

FIG. 2 is a block diagram of a wireless local area network (WLAN) system 200 according to an exemplary embodiment. Referring to FIG. 2, the WLAN system 200 includes a first access point (AP) 210, a second AP 212, a switch 220, and a router 240. FIG. 2 illustrates a case where a wireless terminal performs roaming within the same data link of the same network. In detail, the first AP 210 and the second AP 212 are connected to the router 240 via the switch 220, and are connected to an Internet company network 260 (KORNET) through the router 240. The first AP 210 and the second AP 212 have the same service set identifier (SSID). The first AP 210 and the second AP 212 operate in a network address translation (NAT) mode. The first AP 210 and the second AP 212 have a unique media access control (MAC) address allocated by each manufacturing company. For example, the MAC address of the first AP 210 may be 00:25:A6:A0:AA:1B, and the MAC address of the second AP 220 may be 00:25:A6:A0:10:83. The first AP 210 and the second AP 212 have the same virtual MAC address. For example, the first AP 210 and the second AP 220 may have the same virtual MAC address 00:25:A6:11:00:00. The MAC address is a physical address. However, the MAC address is obtained through software, and thus the MAC address may be generated by software, and the wireless terminal may be set to recognize the MAC address of the first AP 210 and the second AP 212 as the same by the virtual MAC address. The virtual MAC address may be generated based on the original MAC address. The first AP 210 and the second AP 212 may have a virtual MAC address, which is generated in a predetermined scheme. In other words, the WLAN system 200 according to an exemplary embodiment allocates the same virtual MAC address between the first and second APs 210 and 212 having different MAC addresses, and thus even though the connection of the wireless terminal is changed from the first AP 210 to the second AP 212, the wireless terminal belongs to the same network, and thus the IP address, which is provided at the time of connecting to the first AP 210 for the first time, for example, 172.30.1.1, is still valid even after connecting to the second AP 212. This is because the first AP 210 and the second AP 212, which function as a DHCP server for the wireless terminal, have the same virtual MAC address, and thus the DHCP server is the same to the wireless terminal and there is no need for being allocated a new IP address. Hence, even if the IP address is not updated, the network connection is maintained. Consequently, the WLAN system 200 according to an exemplary embodiment may support successful roaming even if the wireless terminal does not request an update of the IP address when the connection of the wireless terminal is changed from the first AP 210 to the second AP 212. Furthermore, the roaming may be simply performed by software in the AP without a complicated circuit operation.

In the WLAN system 200 according to an exemplary embodiment, the first AP 210 and the second AP 212 may be configured to be allocated an IP address of class B or class C. The router 240 may function as a DHCP server having the IP address pool of class B or class C. The first AP 210 and the second AP 212 may be allocated the IP address of class B or class C by the router 240, wherein IP addresses allocated for the first AP 210 and the second AP 212 from B class or C class are different. The first AP 210 and the second AP 212 may have the DHCP server function having the IP address pool of class B or class C. The method of making the MAC address of the first AP 210 and the second AP 212, which is detected by the wireless terminal, the same, by introducing the virtual MAC address concept, may cause a collision between IP addresses. If the IP address pool allocated by the router 240 is class C, the IP address of the first AP 210 and the second AP 212 has an IP address of the same class C, and the number of IP addresses, which may be held by the wireless terminal connected to the first AP 210 and the second AP 212, is merely 253. That is, the IP address, which the wireless terminal has been allocated from the first AP 210, may have already been allocated to another wireless terminal by the second AP 212 and may be used. The IP address pool, which is allocated by the router 240 to prevent a collision of a private IP address allocated to the wireless terminal, may be extended from class C to class B. In this case, the first AP 210 and the second AP 212 may now be allocated the IP address of a different class B by the router 240. For example, the IP addresses, which may be held by the first AP 210, may be 172.30.1.1 to 253. The IP addresses which may be held by the second AP 212 may be 172.30.2.1 to 253. The IP address (third octet is “1”) allocated to the wireless terminal by the first AP 210 cannot be the same as the IP address (third octet is “2”) allocated to the wireless terminal by the second AP 212. Hence, even if the first AP 210 and the second AP 212 have the same MAC address, there is no possibility of a collision of the IP address at the time of roaming.

The switch 120 may be a layer-2 (L2) switch, which is located in a data link layer and is connected to a different data link. The L2 switch performs switching with the MAC address. The L2 switch processes the wireless terminal of an area narrower than that of the router 240, performs a role of transmitting a packet, and transmits the packet to the wireless terminal by using the MAC address of the wireless terminal in the MAC layer. Furthermore, the L2 switch transmits the packet to the wireless terminal by using the mapping information of the physical connection port between the MAC address of the wireless terminal and the AP, which accepts the wireless terminal. The MAC address is also called an Ethernet hardware address, an adapter address, or a physical address. The MAC address is used only when the wireless terminals communicate via the AP, and is not used when disconnecting from the Internet. When disconnecting from the Internet, the MAC is substituted by the MAC address of a sharer.

The router 240 may distinguish the network as the layer-3 router and provide the IP address to the wireless terminal according to the request of the wireless terminal. As such, the wireless terminal within the area belongs to the same network area. That is, the first AP 210 and the second AP 220 belong to the network area of the router 240. The router 240 may accept the L2 switch and transmit packets within the network. The router 240 is a representative layer 3 (L3: network layer) device, checks the destination address of the packet using the routing function and transmits the packet to the destination, and has a routing function of selecting the path to use as the optimal path at the time of transmission. The router 240 may accommodate a plurality of L2 switches.

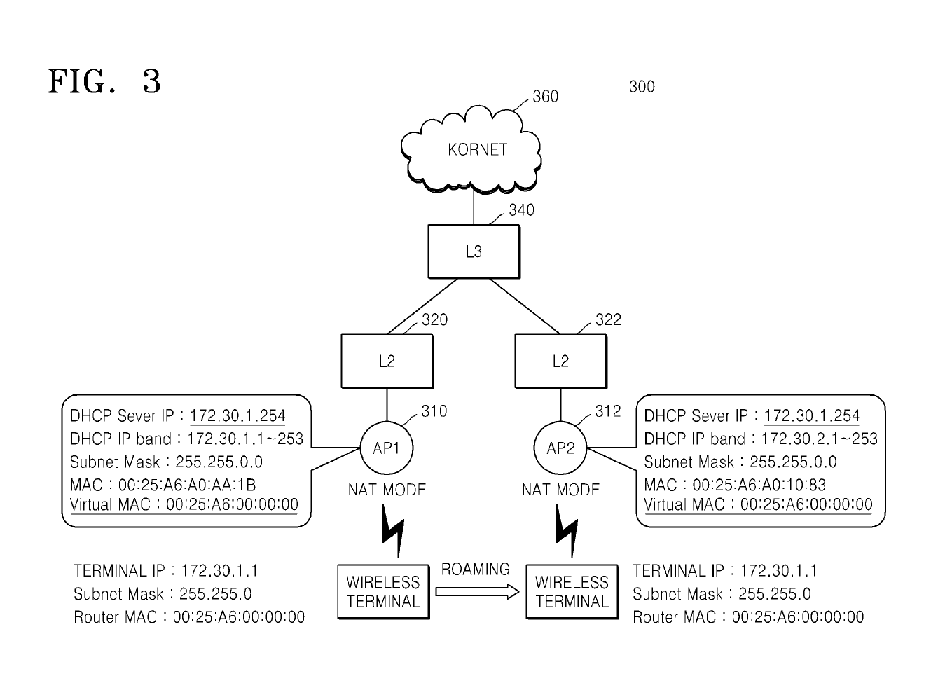

FIG. 3 is a block diagram of a WLAN system according to another exemplary embodiment. Referring to FIG. 3, the WLAN system 300 includes a first AP 310, a second AP 312, a first switch 320, a second switch 322, and a router 340. The first AP 310 is connected to the router 340 via the first switch 320, and the second AP 312 is connected to the router 340 via the second switch 322. Unlike the exemplary embodiment of FIG. 2, the first AP 310 and the second AP 312 are connected to different switches. The exemplary embodiment of FIG. 3 may be a case where the wireless terminal performs roaming to another data link which is distinguished by the first and second switches 320 and 322 within the same network. The first AP 310 and the second AP 312 include the same SSID. The first AP 310 and the second AP 312 operate in a NAT mode. The first AP 310 and the second AP 312 have a unique MAC address allocated by each manufacturing company. The first AP 310 and the second AP 312 have the same virtual MAC address.

In the WLAN according to another exemplary embodiment, the first AP 310 and the second AP 312 may be configured to be allocated the different IP addresses from classes B and C. The router 340 may function as a DHCP server having the IP address pool of class B or class C. The first AP 310 and the second AP 312 may be allocated the different IP addresses from classes B and C by the router 340. The first AP 310 and the second AP 312 may have a function of the DHCP server having the IP address pool of class B or class C. A detailed description of the exemplary embodiment of FIG. 3 is omitted here because it has already been described with reference to FIG. 2.

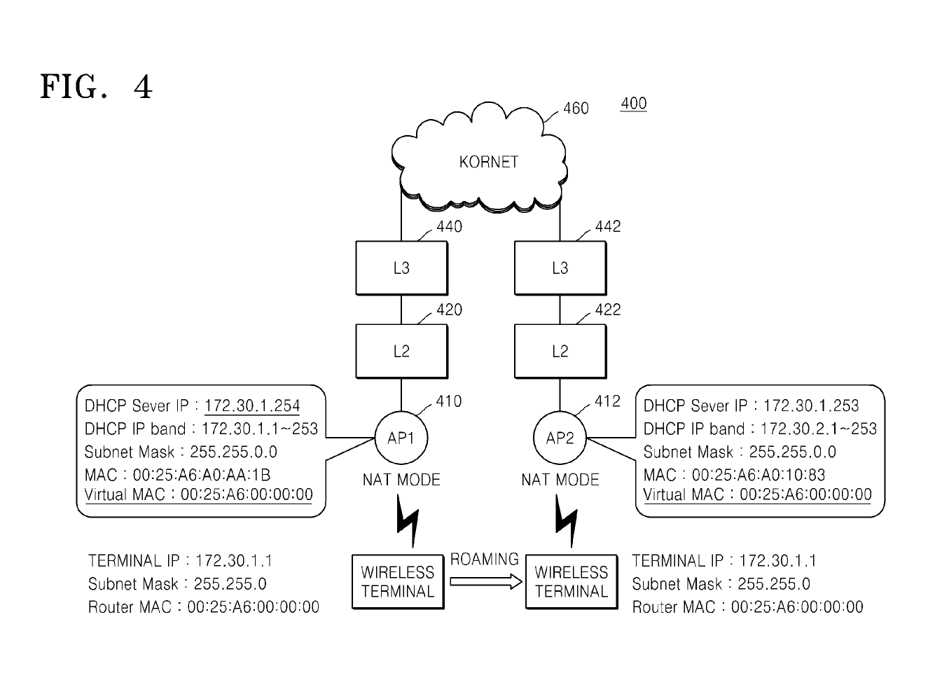

FIG. 4 is a block diagram of a WLAN system 400 according to another exemplary embodiment. Referring to FIG. 4, the WLAN system 400 includes a first AP 410, a second AP 412, a first switch 420, a second switch 422, a first router 440, and a second router 442. The first AP 410 is connected to the first router 440 via the first switch 420, and the second AP 412 is connected to the second router 442 via the second switch 422. Unlike the exemplary embodiments of FIGS. 2 and 3, the first AP 410 and the second AP 412 are connected to different routers via different switches. The exemplary embodiment of FIG. 4 describes a case where a wireless terminal performs roaming to another network which is distinguished by the router 440.

In the WLAN system 400 according to another exemplary embodiment, the first AP 410 and the second AP 412 may be configured to be allocated the IP address of different classes B and C. The router 400 may function as a DHCP server having the IP address pool of class B or class C.

In the case of the exemplary embodiment of FIG. 4, the first AP 410 and the second AP 412 are connected to different routers 440 and 442, and thus the exemplary embodiment of FIG. 4 is different from the exemplary embodiments of FIGS. 2 and 3. Such a difference merely causes a result that the IP address of the DHCP server of the first AP 410 becomes different from the IP address of the DHCP server of the second AP 412. As such, as in the exemplary embodiments of FIGS. 2 and 3, as long as the first AP 410 and the second AP 412 operate in a NAT method, and the virtual MAC address of the first AP 410 becomes the same as the virtual MAC address of the second AP 412, the wireless terminal determines the first AP 410 and the second AP 412 as the same. Hence, a detailed description thereof is omitted because it has been described above with reference to FIG. 2.

The case of applying a virtual MAC address concept, and applying a technical concept of allocating the same virtual MAC address between APs and a technical concept of extending the IP address pool for preventing an IP address collision between wireless terminals at the time of roaming, with respect to the AP, has been described above. However, the exemplary embodiments are not limited thereto, and those of ordinary skill in the art may modify the exemplary embodiments and apply the modified embodiments to the network equipment having a routing function and a DHCP server function.

While the exemplary embodiments have been particularly shown, it will be understood by those of ordinary skill in the art that various changes in form and details may be made therein without departing from the spirit and scope of the present invention as defined by the following claims.

1. A wireless local area network (WLAN) system based on an access point (AP), the WLAN system comprising:
a first AP; and
a second AP which has a same service set identifier (SSID) as that of the first AP,
wherein the first AP and the second AP are configured to respectively perform a network address translation (NAT) and have a same virtual media access control (MAC) address.

2. The WLAN system of claim 1, wherein the first AP and the second AP are configured to generate the virtual MAC address according to a predetermined scheme.

3. The WLAN system of claim 2, wherein the virtual MAC address is generated based on an original MAC address which has been set at a time of manufacturing.

4. The WLAN system of claim 1, wherein the first AP and the second AP are respectively connected to a first router via a first switch.

5. The WLAN system of claim 1, wherein the first AP is connected to a first router via a first switch, and the second AP is connected to the first router via a second switch.

6. The WLAN system of claim 1, wherein the first AP is connected to a first router via a first switch, and the second AP is connected to a second router via a second switch.

7. The WLAN system of claim 4, wherein the first router is configured to function as a dynamic host configuration protocol (DHCP) server having an internet protocol (IP) address pool of a first class or a second class.

8. The WLAN system of claim 7, wherein the first AP and the second AP are configured to be allocated an IP address band of the first class and the second class, which are different classes.

9. The WLAN system of claim 8, wherein the first AP and the second AP are respectively configured to function as a DHCP server having the IP address pool of the first class and the second class.

10. The WLAN of claim 6, wherein the first router and the second router are respectively configured to function as a dynamic host configuration protocol (DHCP) server having the IP address pool of a first class and a second class.

11. The WLAN of claim 10, wherein the first AP and the second AP are configured to be allocated an IP address band of the first class and the second class, where the first class and the second class are different classes.

12. The WLAN system of claim 11, wherein the first AP and the second AP are respectively configured to function as a DHCP server having the IP address pool of the first class and the second class.

13. The WLAN system of claim 5, wherein the first router is configured to function as a dynamic host configuration protocol (DHCP) server having an internet protocol (IP) address pool of a first class or a second class.
